(19) United States
(12) Patent Application Publication
(10) Pub. No.: US 2023/0025381 A1
(43) Pub. Date: Jan. 26, 2023

(54) POSITION OBSERVATION SYSTEM AND STORAGE MEDIUM STORING POSITION OBSERVATION PROGRAM

(71) Applicant: KABUSHIKI KAISHA TOSHIBA, Tokyo (JP)

(72) Inventor: Hiroaki NAKAMURA, Kawasaki (JP)

(73) Assignee: KABUSHIKI KAISHA TOSHIBA, Tokyo (JP)

(21) Appl. No.: 17/653,928

(22) Filed: Mar. 8, 2022

(30) Foreign Application Priority Data
Jul. 26, 2021 (JP) 2021-121830

(51) Int. Cl. G01S 17/46; G01S 17/88

(52) U.S. Cl. CPC G01S 17/46; G01S 17/88

(57) ABSTRACT

According to one embodiment, a position observation system includes a sensor and a processor. The sensor is arranged to face a first opening of a through hole included in a first target object. The sensor projects a light beam for scanning the through hole and receives reflection light of the light beam from a second target object that is to be inserted through a second opening of the through hole into the through hole. The processor including hardware. The processor generates an image based on the reflection light received by the sensor, and displays the image on a display device.

### CROSS-REFERENCE TO RELATED APPLICATIONS

This application is based upon and claims the benefit of priority from Japanese Patent Application No. 2021-121830, filed Jul. 26, 2021, the entire contents of which are incorporated herein by reference.

### FIELD

Embodiments described herein relate generally to a position observation system and a storage medium storing a position observation program.

### BACKGROUND

In a railway vehicle, a car body and a bogie are coupled by inserting a pin provided on the car body into a pin bearing provided on the bogie. Due to the heaviness of the car body, if the alignment of the pin and the pin bearing is inaccurate, the bogie may be damaged at the time of coupling the car body and the bogie.

Conventionally, the relative positions of the pin and pin bearing are observed through a visual inspection by a worker. For this visual inspection, a pit may be dug in the floor on which a bogie is placed, and a worker can observe a pin through a pin bearing from this pit. Since the digging of a pit incurs considerable costs, there is a demand for an observation method with lower costs.

### BRIEF DESCRIPTION OF THE DRAWINGS

FIG. 1 is a diagram showing an application example of a position observation system according to an embodiment.

FIG. 2 is a diagram showing the configuration of the position observation system according to the embodiment.

FIG. 3 is a diagram showing an exemplary hardware configuration of the position observation apparatus.

FIG. 4 is a flowchart of the operation of the position observation apparatus.

FIG. 5A is a diagram showing a relationship between a light beam projected from a sensor and a pin when a large amount of horizontal displacement is observed between the pin and a pin bearing.

FIG. 5B is a diagram showing an exemplary infrared image obtained for the situation of FIG. 5A.

FIG. 6A is a diagram showing a relationship between a light beam projected from the sensor and the pin when a small amount of horizontal displacement is observed between the pin and the pin bearing.

FIG. 6B is a diagram showing an exemplary infrared image obtained for the situation of FIG. 6A.

FIG. 7A is a diagram showing a relationship between a light beam projected from the sensor and the pin that is being brought closer to the pin bearing with a small amount of horizontal displacement between the pin and the pin bearing.

FIG. 7B is a diagram showing an exemplary infrared image obtained for the situation of FIG. 7A.

FIG. 8A is a diagram showing a change in a depth image corresponding to the positional relationship between the pin and the pin bearing in the vertical direction.

FIG. 8B is a diagram showing a change in a depth image corresponding to the positional relationship between the pin and the pin bearing in the vertical direction.

### DETAILED DESCRIPTION

In general, according to one embodiment, a position observation system includes a sensor and a processor. The sensor is arranged to face a first opening of a through hole included in a first target object. The sensor projects a light beam for scanning the through hole and receives reflection light of the light beam from a second target object that is to be inserted through a second opening of the through hole into the through hole. The processor including hardware. The processor generates an image based on the reflection light received by the sensor, and displays the image on a display device.

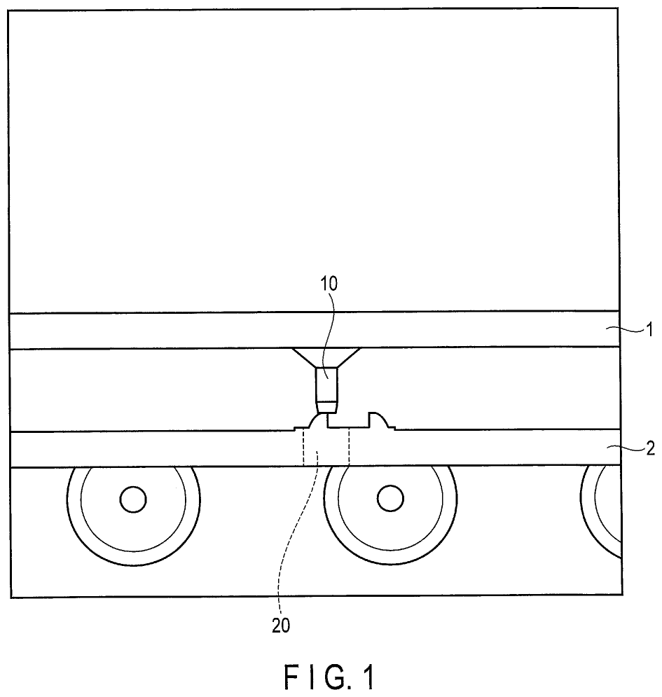

Hereinafter, embodiments will be described with reference to the drawings. FIG. 1 is a diagram showing an application example of a position observation system according to an embodiment. The position observation system according to the embodiment may be adopted, for example, for coupling a car body 1 and a bogie 2 of a railway vehicle.

The car body 1 may be hoisted by a not-shown crane in a movable manner in a horizontal direction parallel to the floor surface on which the bogie 2 is placed and also in a vertical direction with respect to the floor surface. A pin 10 is provided as an exemplary second target object on the bottom portion of the car body 1. The pin 10 may be an approximately columnar pin, and one or more pins are formed for a car body 1. The cross-sectional shape of the pin 10 may not necessarily be circular.

The bogie 2 is secured to a predetermined position on the floor surface. A pin bearing 20 is provided on the bogie 2 as an exemplary first target object. The pin bearing 20 is a through hole formed in the bogie 2. The shape of the pin bearing 20 may be determined in accordance with the shape of the pin 10. The cross-sectional shape of the pin bearing 20 may be the same as that of the pin 10 or may differ from that of the pin 10. For instance, the cross-sectional shape of the pin 10 may be circular, while the cross-sectional shape of the pin bearing 20 may be oval. Hereinafter, the opening portion of the pin bearing 20 on the side that faces the floor surface will be referred to as a first opening, and the opening portion of the pin bearing 20 on the side that faces the car body 1 will be referred to as a second opening.

When coupling the car body 1 with the bogie 2, a worker manipulates the crane while observing the relative positions of the pin 10 and pin bearing 20 with the position observation system according to the present embodiment so as to insert the pin 10 of the car body 1 into the pin bearing 20 of the bogie 2.

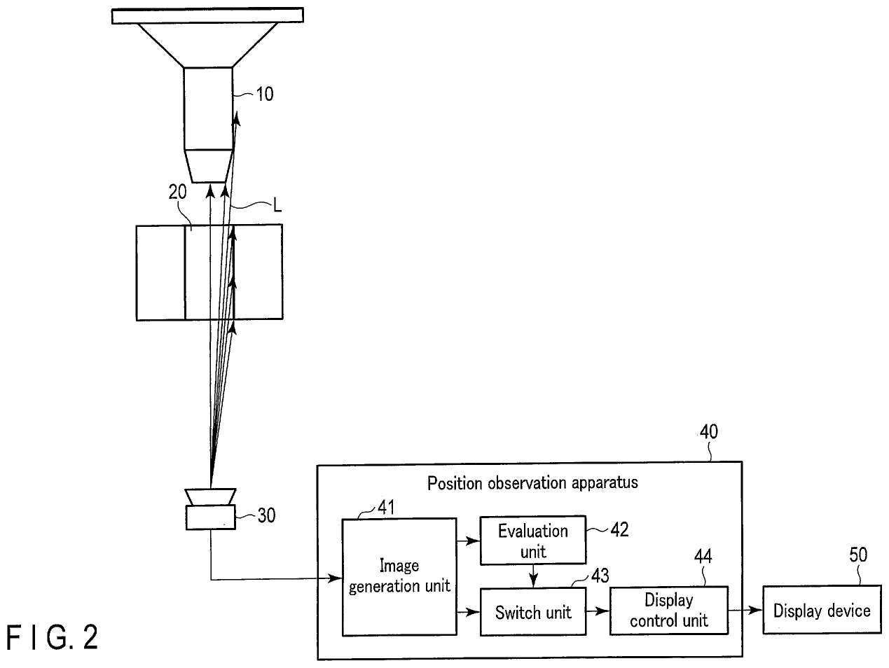

FIG. 2 is a diagram showing the configuration of the position observation system according to the embodiment. The position observation system includes a sensor 30 and a position observation apparatus 40.

The sensor 30 is arranged on the floor surface where it faces the first opening of each of the pin bearings 20. In particular, the sensor 30 is arranged such that the center position of its light receiving surface falls on the central axis of the through hole of the pin bearing 20. The sensor 30 may be a depth camera of light detecting and ranging (LiDAR) scheme. A LiDAR depth camera may include, for example, a light source, a deflector, and a photoreceptor. The light source may be an infrared light source, which emits an infrared light beam toward the deflector. The deflector may include a microelectromechanical system (MEMS) mirror, through the control of which the direction of the light beam emission can be altered and the pin 10 can be conically scanned via the pin bearing 20. The photoreceptor may have a light receiving surface on which pixels of components such as photodiodes and single-photon avalanche diodes (SPAD) sensitive to the infrared range are two-dimensionally arranged.

The sensor 30 according to the present embodiment projects an infrared light L through the first opening, which is an opening in the bottom of the pin bearing 20, and receives the reflection light of the infrared light L that exits through the second opening and is reflected by the pin 10. Thereafter, the sensor 30 sends to the position observation apparatus 40 sensor data which is based on this reflection light. The sensor data may include data representing the brightness of the reflection light and data representing a temporal difference between the projection and reception of the light.

The sensor 30 is configured to conically scan a pin 10 through a pin bearing 20. The configuration of the sensor 30 is not particularly limited as long as the sensor 30 is capable of performing scanning with a light beam L in such a manner that the light beam L will be normally incident with respect to the center of the second opening and obliquely incident with respect to the edge of the second opening. The configuration of the sensor 30 is not necessarily limited to the one for performing the light beam scanning with a mirror.

The position observation apparatus 40 includes an image generation unit 41, an evaluation unit 42, a switch unit 43, and a display control unit 44. The position observation apparatus 40 is configured to be communicable with the sensor 30. The communication between the position observation apparatus 40 and sensor 30 may be established in a wireless or wired manner. Furthermore, the position observation apparatus 40 is also configured to be communicable with the display device 50. Examples for the display device 50 include a liquid crystal display and an organic EL display. The display device 50 displays various types of images based on the data transferred from the position observation apparatus 40. The communication between the position observation apparatus 40 and display device 50 may be established in a wireless or wired manner.

The image generation unit 41 generates images based on the sensor data acquired from the sensor 30. The image generation unit 41 may generate a first image having pixel values corresponding to the brightness of the reflection light and a second image having pixel values corresponding to a depth calculated based on the reflection light. The first image is an infrared image generated by assigning a value to each of the pixels in accordance with the brightness values of the infrared light detected at respective scanning positions of the sensor 30. On the other hand, the second image is a depth image generated by assigning a value to each of the pixels in accordance with the depth values calculated based on the temporal difference, for example, between the projection and reception of the infrared light detected at respective scanning positions of the sensor 30.

The evaluation unit 42 evaluates the displacement of the pin 10 and pin bearing 20 by evaluating the first image or second image at the image generation unit 41. The evaluation method for the displacement will be described later in detail.

In accordance with the evaluation result obtained by the evaluation unit 42, the switch unit 43 switches an image to be output to the display control unit 44 between the first image and second image. This switching will be described later in detail.

The display control unit 44 displays an image input from the switch unit 43 on the display device 50. The display control unit 44 may also display various types of information on the display device 50 as needed, by superposing it on the image input from the switch unit 43.

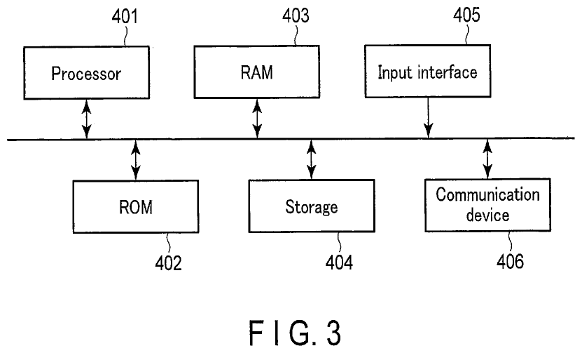

FIG. 3 is a diagram showing an exemplary hardware configuration of the position observation apparatus 40. The position observation apparatus 40 may be any type of terminal device such as a personal computer (PC) and a tablet terminal. As illustrated in FIG. 3, the position observation apparatus 40 includes, as its hardware configuration, a processor 401, a ROM 402, a RAM 403, a storage 404, an input interface 405, and a communication device 406.

The processor 401 is configured to control the overall operation of the position observation apparatus 40. By executing a program stored in the storage 404, the processor 401 may function as the image generation unit 41, evaluation unit 42, switch unit 43, and display control unit 44. The processor 401 may be a central processing unit (CPU). The processor 401 may also be a microprocessing unit (MPU), a graphics processing unit (GPU), an application specific integrated circuit (ASIC), a field programmable gate array (FPGA), or the like. The processor 401 may be a single CPU, or multiple CPUs.

The read-only memory (ROM) 402 is a non-volatile memory. The ROM 402 stores a startup program for the position observation apparatus 40, various threshold values, and the like. The random access memory (RAM) 403 is a volatile memory. The RAM 403 may be used as a working memory used, for instance, at the time of the processing at the processor 401.

The storage 404 may be a hard disk drive or solid state drive. The storage 404 stores various programs, such as a position observation program, to be executed by the processor 401.

The input interface 405 includes input devices such as a touch panel, a keyboard, and a mouse. When the input device of the input interface 405 is manipulated, a signal corresponding to the manipulation is input to the processor 401. The processor 401 executes various types of processing in response to this signal.

The communication device 406 is provided to enable the position observation apparatus 40 to establish communication with external devices such as the sensor 30 and display device 50. The communication device 406 may be a device for wired communication or for wireless communication.

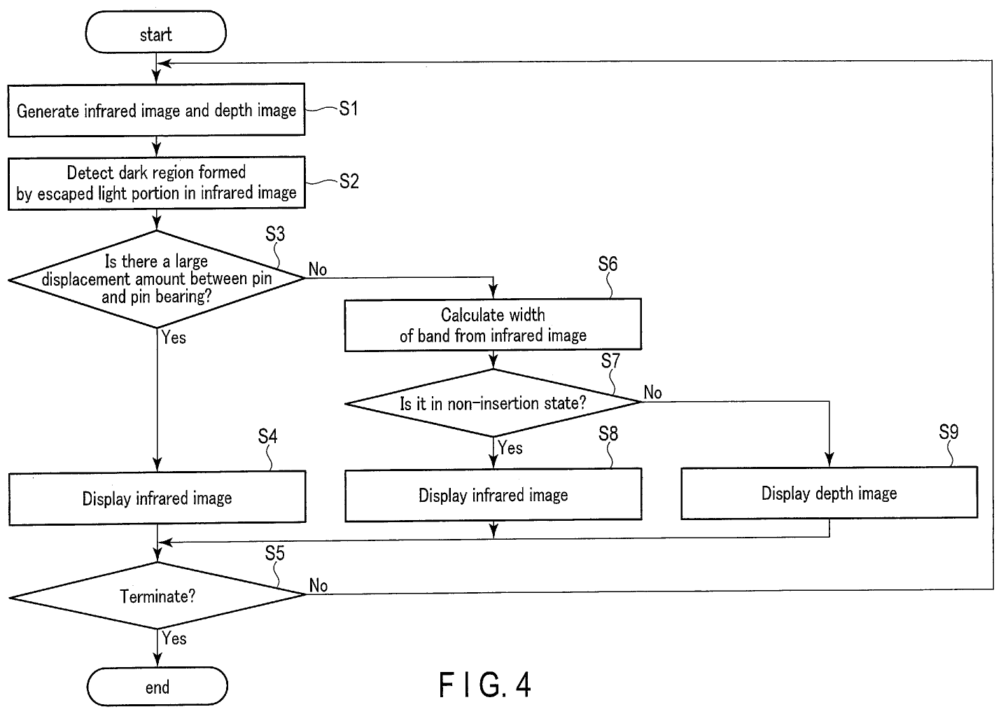

Next, the operation of the position observation system will be explained. FIG. 4 is a flowchart of the operation of the position observation apparatus 40. The processing in FIG. 4 is executed by the processor 401. During the processing of FIG. 4, the worker manipulates the crane while looking at the image displayed on the display device 50 in order to insert the pin 10 of the car body 1 into the pin bearing 20 of the bogie 2. Here, the sensor 30 projects the light beam towards the pin bearing 20 and thereby scans the pin 10 through the pin bearing 20. The sensor 30 successively sends the sensor data to the position observation apparatus 40. Upon receipt of the sensor data, the processor 401 initiates the processing of FIG. 4.

At step S1, based on the sensor data from the sensor 30, the processor 401 generates an infrared image as the first image and a depth image as the second image. As mentioned earlier, in the infrared image, pixel values are assigned to the pixels in accordance with the brightness of the infrared light obtained from the sensor data. In the depth image, pixel values are assigned to the pixels in accordance with the depth calculated based on the temporal difference between the projection and reception of the infrared light obtained from the sensor data.

At step S2, the processor 401 detects a dark region in the infrared image. The dark region of the infrared image will be explained below.

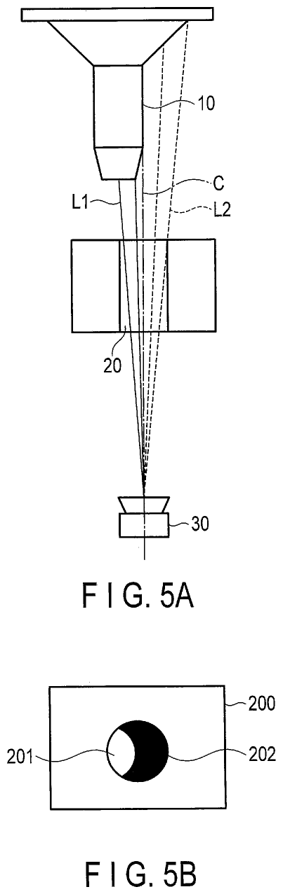

FIG. 5A shows the relationship between the pin 10 and a light beam projected from the sensor 30 when a large amount of horizontal displacement is observed between the pin 10 and pin bearing 20. According to the embodiment, the beam is conically projected by the sensor 30. That is, the light beam is obliquely incident through the edge of the second opening of the pin bearing 20. Thus, as illustrated in FIG. 5A, when the center of the pin 10 is considerably displaced from the center C of the pin bearing 20, part of the light, i.e., a light beam L1, projected by the sensor 30 and exiting through the second opening of the pin bearing 20 is reflected at the tip of the pin 10, while some other part of the light, i.e., a light beam L2, does not hit the tip of the pin 10 but escapes alongside the side surface of the pin 10. Thus, no reflection light of the light beam L2 may be returned, or even if there is some that is returned, it will be much weaker than the reflection light of the light beam L1. When the center of the pin 10 is considerably displaced from the center C of the pin bearing 20, the light beam L2 will be lopsided and will exit through a certain portion of the pin bearing 20. In the example of FIG. 5A, the emission of the light beam L2 is lopsided to the right side of the pin bearing 20.

FIG. 5B is a diagram showing an exemplary infrared image obtained for the situation of FIG. 5A. In comparison with the reflection light of the light beam L1, the reflection light of the light beam L2 is very weak. As a result, in the infrared image 200, the region based on the reflection light of the light beam L1 appears as a bright region 201 depicting the shape of the tip of the pin 10, while the region based on the reflection light of the light beam L2 turns out to be a dark region 202. Here, if there is a large displacement between the pin 10 and pin bearing 20 in the horizontal direction, the light beam L2 will be lopsided, which will result in the dark region 202 asymmetrically shaped with respect to the center of the circle representing the pin bearing 20.

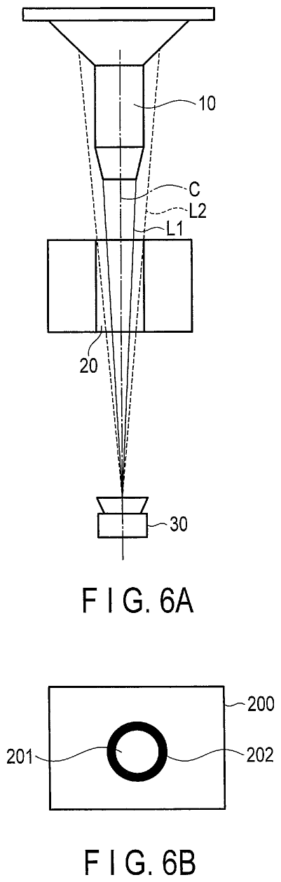

FIG. 6A shows the relationship between the pin 10 and a light beam projected from the sensor 30 when a small amount of horizontal displacement is observed between the pin 10 and pin bearing 20. As illustrated in FIG. 6A, when the center of the pin 10 approximately matches with the center C of the pin bearing 20, a portion of the light beam L2 projected by the sensor 30 and exiting through the second opening of the pin bearing 20 escapes without hitting the tip of the pin 10. However, in the case of the center of the pin 10 approximately matching with the center C of the pin bearing 20, the light beam L2 substantially evenly exits through the second opening of the pin bearing 20 along the edge thereof.

FIG. 6B is a diagram showing an exemplary infrared image obtained in response to the situation of FIG. 6A. With the light beam L2 being substantially evenly emitted through the edge of the second opening of the pin bearing 20, the shape of the dark region 202 of the infrared image 200 will form a symmetrical band with respect to the center of the pin bearing 20.

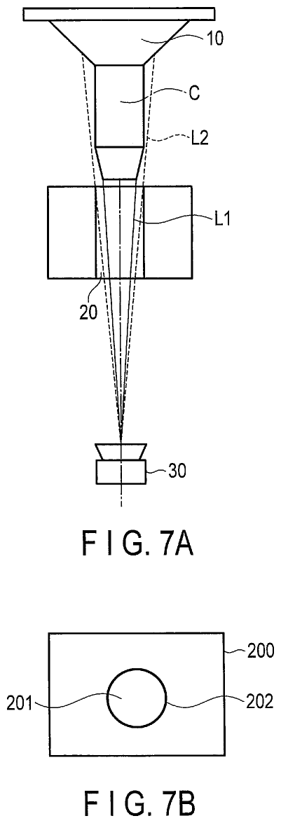

FIG. 7A is a diagram showing a relationship between a light beam projected from the sensor 30 and the pin 10 which is being brought closer to the pin bearing 20 with a small amount of horizontal displacement between the pin 10 and the pin bearing 20. As illustrated in FIG. 7A, as the distance between the pin 10 and pin bearing 20 decreases, the light beam L2 that escapes alongside the side surface of the pin 10 is narrowed.

FIG. 7B is a diagram showing an exemplary infrared image obtained for the situation of FIG. 7A. With the light beam L2 narrowed, the band formed by the dark region 202 of the infrared image 200 is narrowed in comparison with the band formed when there is a large distance between the pin 10 and pin bearing 20. After the pin 10 is inserted into the pin bearing 20, the band of the dark region 202 in the infrared image 200 substantially disappears.

As described above, the shape of the dark region 202 varies in accordance with a degree of the displacement between the pin 10 and pin bearing 20. This means that the amount of displacement between the pin 10 and pin bearing 20 can be evaluated from the shape of the dark region 202. Based on this principle, the processor 401 detects a region having pixel values lower than a predetermined value in the infrared image 200 as a dark region 202.

At step S3, the processor 401 determines whether the amount of displacement between the pin 10 and pin bearing 20 is large. The processor 401 determines that the amount of displacement between the pin 10 and pin bearing 20 is large, for example, when the shape of the dark region 202 does not exhibit a symmetric property greater than or equal to a predetermined value with respect to the center of the circle representing the pin bearing 20. It may be determined that the shape of the dark region 202 is symmetric when the pin 10 is not positioned over the pin bearing 20 at all. If this is the case, however, no bright region 201 will be present. In such an infrared image 200, if no boundary between the bright region 201 and dark region 202 can be observed, the processor 401 determines that the amount of displacement between the pin 10 and pin bearing 20 is large. At step S3, when it is determined that the amount of displacement between the pin 10 and pin bearing 20 is large, the process proceeds to step S4. At step S3, when it is determined that the amount of displacement between the pin 10 and pin bearing 20 is not large, the process proceeds to step S6.

At step S4, the processor 401 displays the infrared image on the display device 50. Thereafter, the processor 401 moves the process to step S5. With the infrared image of FIG. 5A displayed on the display device 50, the worker can observe the displacement between the pin 10 and pin bearing 20 on the display device 50. In addition to the infrared image of FIG. 5A, a guide for the manipulation direction of the crane in accordance with the direction of the displacement between the pin 10 and pin bearing 20, which is determined based on the symmetric property of the dark region 202, may also be displayed.

At step S5, the processor 401 determines whether the operation of the position observation apparatus 40 should be terminated. For instance, when the worker's manipulation of the input interface 405 indicates a termination of the operation, the processor 401 determines that the operation of the position observation apparatus 40 is to be terminated. When it is determined at step S5 that the operation of the position observation apparatus 40 is to be terminated, the process of FIG. 4 is terminated. When it is not determined at step S5 that the operation of the position observation apparatus 40 is to be terminated, the process returns to step S1.

At step S6, the processor 401 calculates the width of the band formed by the dark region 202 in the infrared image 200.

At step S7, the processor 401 determines whether the pin 10 is in a non-insertion state with respect to the pin bearing 20. The processor 401 may determine that the pin 10 is in a non-insertion state with respect to the pin bearing 20 when the width of the band of the dark region 202 is larger than a predetermined threshold value. At step S7, when it is determined that the pin 10 is in a non-insertion state with respect to the pin bearing 20, the process proceeds to step S8. At step S7, when it is determined that the pin 10 has been inserted into the pin bearing 20, the process proceeds to step S9.

At step S8, the processor 401 displays the infrared image on the display device 50. Thereafter, the processor 401 moves the process to step S5. With the infrared image of FIG. 6B or 7B displayed on the display device 50, the worker can observe on the display device 50 that the horizontal displacement between the pin 10 and pin bearing 20 has decreased. The worker can also add fine adjustments to the pin 10 and pin bearing 20 in the horizontal direction while checking the width of the band in the infrared image. In addition to the infrared image of FIG. 6B or 7B, a guide for the manipulation direction of the crane in accordance with the direction of the displacement between the pin 10 and pin bearing 20, which is determined based on the width of the band of the dark region 202, may also be displayed.

At step S9, the processor 401 displays the depth image on the display device 50. Thereafter, the processor 401 moves the process to step S5. As mentioned earlier, after the pin 10 is inserted into the pin bearing 20, the band of the dark region 202 in the infrared image 200 substantially disappears. The worker, however, needs to manipulate the crane so as to completely insert the pin 10 into the pin bearing 20. If the crane is lowered too far, the car body 1 may come into contact with the bogie 2, breaking the bogie 2. For this reason, it is preferable that to the amount of insertion of the pin 10 into the pin bearing 20 be observable. On the infrared image 200, however, it is difficult to check the positional relationship between the pin 10 and pin bearing 20 in the vertical direction. Thus, after the pin 10 is inserted, the processor 401 switches the image to be displayed on the display device 50 from the infrared image to a depth image.

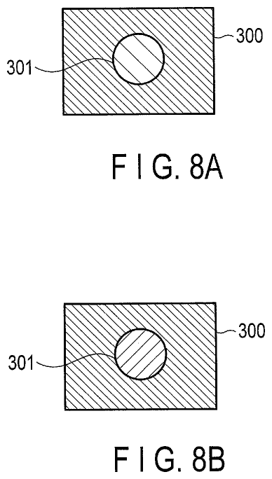

FIGS. 8A and 8B are diagrams showing a change in depth images corresponding to the positional relationship between the pin 10 and the pin bearing 20 in the vertical direction. In a depth image 300, pixel values are assigned in accordance with the depth from the sensor 30, as illustrated in FIG. 8A. The positional relationship between the pin 10 and pin bearing 20 is thereby represented. That is, when the pin 10 and pin bearing 20 establish a certain positional relationship in a vertical direction, a portion 301 of the pin 10 in the depth image 300 exhibits a pixel value corresponding to the distance between the sensor 30 and pin 10 as illustrated in FIG. 8A. On the other hand, when the pin 10 is further inserted into the pin bearing 20, the portion 301 of the pin 10 in the depth image 300 exhibits a pixel value, as illustrated in FIG. 8B, which differs from that of FIG. 8A. This allows the worker to ascertain on the display device 50 the insertion condition of the pin 10 with respect to the pin bearing 20.

Between the image of the portion 301 of the pin 10 in FIG. 8A and the image of the portion 301 of the pin 10 in FIG. 8B, not only pixel values but also colors may be changed. By changing the colors or the like in accordance with the positional relationship between the pin 10 and pin bearing 20 in the vertical direction, the worker can easily ascertain the positional relationship on the image displayed on the display device 50.

As described above, according to the present embodiment, in order to observe the positional relationship between the first target object and the second target object when the second target object is inserted into the first target object having a through hole from one opening of the through hole, a sensor that is arranged to face the other opening of the through hole to project a light beam for scanning the through hole and receive the reflection light of the light beam from the second target object is adopted. In this situation, the light beam may escape depending on the positional relationship between the first target object and second target object in a direction horizontal to the cross section of the through hole. This escaped light beam is detected as a dark region in an image so that the positional relationship between the first target object and second target object can be evaluated on the image. Furthermore, with a display of such an image including a dark region, the worker can observe the positional relationship between the first target object and second target object. According to the present embodiment, since the sensor only needs to be placed in such a manner that it faces the through hole, there is no need to form a pit or the like, and a position observation system can be realized at reduced costs.

In addition, according to the present embodiment, the observation of the relative positions can be conducted without setting a reference position such as a marker on a target object and without detecting a reference position such as a marker on an image. The embodiment is therefore particularly preferable for the observation of the relative positions of large objects.

According to the embodiment, after the second target object is inserted into the first target object, the image to be displayed on the display device is switched from the first image having pixel values corresponding to the brightness of the reflection light to the second image having pixel values corresponding to the depth from the sensor calculated based on the reflection light. This allows the worker to observe the insertion condition of the first target object and second target object on the image even after the second target object is inserted into the first target object.

According to the present embodiment, infrared light is used as a light beam. Thus, even when the environment is not in the light, the relative positions via a through hole can be observed.

### Modification Examples

Modification examples of the present embodiment will be explained below. In the aforementioned embodiment, after the second target object is inserted into the first target object, the image to be displayed on the display device is switched from the first image having pixel values corresponding to the brightness of the reflection light to the second image having pixel values corresponding to the depth from the sensor calculated based on the reflection light. The image to be displayed on the display device may be the second image even before the second target object is inserted into the first target object. If this is the case, the dark region 202 is generated as an image representing a relatively long distance.

In the embodiment, infrared light is adopted as a light beam; however, a visible light may be adopted as a light beam if the through hole is in the illuminated environment. If this is the case, a color image is displayed on the display device 50 in place of the infrared image.

In the embodiment, both an infrared image and a depth image are generated at step S1; however, the depth image may be generated in the operation at step S9.

In the embodiment, the image to be displayed on the display device 50 is automatically switched from an infrared image to a depth image when it is determined that the pin 10 has been inserted into the pin bearing 20. The images to be displayed on the display device 50 may be switched by a worker manipulating the input interface 405. If this is the case, the determination to be made at step S7 is whether a switching manipulation by the worker is input. When it is determined that the switching manipulation is input, the processor 401 moves the process to step S9. Alternatively, automatic switching and manual switching from an infrared image to a depth image may be adopted in combination. If this is the case, it is determined as to whether the pin 10 is in a non-insertion state with respect to the pin bearing 20 as illustrated in step S7 of FIG. 4 and whether a switching manipulation is input by the worker.

In the embodiment, an exemplary use of the position observation system for coupling a car body and a bogie of a railway vehicle is described. The position observation system of the embodiment is not limited to the use of coupling a car body and a bogie of a railway vehicle. If this is the case, the sensor does not need to be arranged at the bottom of the first target object. If the second target object is inserted through the bottom opening of the through hole, the sensor may be arranged to face the upper opening of the through hole. If the second target object is inserted from one opening of a horizontal through hole, the sensor may be arranged to face the other opening of the through hole.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A position observation system comprising:
a sensor arranged to face a first opening of a through hole included in a first target object and configured to project a light beam for scanning the through hole and receive reflection light of the light beam from a second target object that is to be inserted through a second opening of the through hole into the through hole; and
a processor including hardware, the processor configured to
generate an image based on the reflection light received by the sensor, and
display the image on a display device.

2. The position observation system according to claim 1, wherein
the processor is configured to evaluate a displacement of the second target object with respect to the through hole based on the image.

3. The position observation system according to claim 2, wherein
the image includes a first image having a pixel value corresponding to a brightness of the reflection light, and
the processor is configured to evaluate the displacement of the second target object with respect to the through hole based on a symmetric property of a dark region formed at a position of the through hole on the image.

4. The position observation system according to claim 3, wherein
the image further includes a second image having a pixel value corresponding to a depth from the sensor calculated based on the reflection light, and
the processor is configured to automatically switch the image to be displayed on the display device from the first image to the second image when the second target object is inserted into the through hole.

5. The position observation system according to claim 3, wherein
the image further includes a second image having a pixel value corresponding to a depth from the sensor calculated based on the reflection light, and
the system further comprises a manipulation unit configured to receive a manipulation operation for switching the image to be displayed on the display device from the first image to the second image.

6. The position observation system according to claim 1, wherein
the light beam is an infrared beam.

7. The position observation system according to claim 1, wherein
the sensor is configured to project the light beam for scanning in such a manner that the light beam is normally incident with respect to a center of the second opening and is obliquely incident with respect to an edge of the second opening.

8. A computer-readable non-transitory storage medium storing a position observation program that causes a computer to:
scan a through hole included in a first target object with a light beam projected from a sensor that is arranged to face a first opening of the through hole;
receive a reflection light of the light beam from a second target object that is to be inserted through a second opening of the through hole into the through hole;
generate an image based on the reflection light received by the sensor; and
display the image on a display device.
